(19) United States
(12) Patent Application Publication
(10) Pub. No.: US 2009/0279736 A1
(43) Pub. Date: Nov. 12, 2009

(54) MAGNETIC RESONANCE EYE TRACKING SYSTEMS AND METHODS

(76) Inventors: Stephen LaConte, Houston, TX (US); Keith Aaron Heberlein, Erlangen (DE); Scott James Peltier, Whitmore Lake, MI (US); Xiaoping Philip Hu, Tucker, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/295,317

(22) PCT Filed: Apr. 23, 2007
(86) PCT No.: PCT/US07/67192

§ 371 Date: Sep. 30, 2008

Related U.S. Application Data
(60) Provisional application No. 60/793,887, filed on Apr. 21, 2006.

(51) Int. Cl. G06T 7/00

(52) U.S. Cl. 382/103

(57) ABSTRACT

Embodiments of magnetic resonance eye tracking systems and methods are disclosed. One embodiment, among others, comprises a method that receives magnetic resonance based data and determines direction of a subject's gaze based on the data.

### CROSS-REFERENCE TO RELATED APPLICATION

This application claims priority to copending U.S. provisional application entitled, “MAGNETIC RESONANCE EYE TRACKING SYSTEMS AND METHODS,” having Ser. No. 60/793,887, filed Apr. 21, 2006, which is entirely incorporated herein by reference.

### STATEMENT REGARDING FEDERALLY SPONSORED RESEARCH OR DEVELOPMENT

This invention was made with government support under grant number R01EB002009 and R21NS050183 awarded by the NIH. The government has certain rights in the invention.

### TECHNICAL FIELD

The present disclosure is generally related to imaging systems, and, more particularly, is related to magnetic resonance imaging systems and methods.

### BACKGROUND

Eye tracking data is commonly recorded using specialized equipment during cognitive studies or clinical tests. The most common eye tracking approach in a magnetic resonance imaging (MRI) environment is to use reflected infrared light from the cornea to track eye movement and determine fixation. Installation of such a system can pose a significant challenge since the optics and path of the transmitted and reflected infrared light usually must avoid interference with the visual paradigm display and are confined within the limited access to the subject's eye within the scanner. During an experiment, setup of the optics extends the time of the experiment. In addition, the quality of the infrared image from standard eye tracking data may not be sufficient for accurate determination of the position of the pupil. Another drawback is that magnetic resonance compatible eye-tracking systems are generally expensive.

### SUMMARY

Embodiments of the present disclosure provide magnetic resonance eye tracking systems and methods.

Briefly described, in architecture, one embodiment of the system, among others, comprises memory with software stored therein, and a processor configured with the software to receive first eye fixation coordinates and first image data corresponding to a calibration scan, generate one or more models based on the first eye fixation coordinates and the first image data, receive second image data corresponding to a non-calibration scan, and estimate a subject's eye fixation based on the second image data and the one or more models.

Embodiment of the present disclosure can also be viewed as magnetic resonance eye tracking methods. In this regard, one embodiment of such a method, among others, can be broadly summarized as receiving magnetic resonance based data and determining direction of a subject's gaze based on the data.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the disclosed systems and methods. Moreover, in the drawings, like reference numerals designate corresponding parts throughout the several views.

FIGS. 1-2 are functional block diagrams that illustrate an embodiment of a magnetic resonance eye tracking system.

FIG. 3 is a block diagram that illustrates a magnetic resonance eye tracking software embodiment of the magnetic resonance eye tracking system shown in FIGS. 1-2.

FIG. 4 is a flow diagram that illustrates a magnetic resonance eye tracking method embodiment of the magnetic resonance eye tracking software shown in FIG. 3.

FIG. 5 is a flow diagram that illustrates a magnetic resonance eye tracking method embodiment of the magnetic resonance eye tracking software shown in FIG. 3.

FIG. 6 is a flow diagram that illustrates a magnetic resonance eye tracking method embodiment of the magnetic resonance eye tracking software shown in FIG. 3.

FIGS. 7 and 8 are schematic diagrams that illustrate experimental results for vertical tracking for a subject according to the method embodiments described in FIGS. 4-6.

### DETAILED DESCRIPTION

Disclosed herein are various embodiments of magnetic resonance eye tracking systems and methods (herein, also referred to collectively as magnetic resonance eye tracking systems). At least one goal of such magnetic resonance eye tracking systems is to determine (e.g., estimate) a subject's direction of gaze from a subject's magnetic resonance (MR) signal such that the MR signal alone can lead to an estimate of the true direction of gaze. Thus, the magnetic resonance eye tracking systems disclosed herein utilize a nuclear magnetic resonance (NMR) signal or, broadly speaking, the MR signal itself, to determine a subject's gaze, and hence the movement of the eye. That is, magnetic resonance eye tracking systems as described herein include the use of NMR to determine physical properties of the eye such as direction of gaze, and amount of eye movement over a period of time.

Since the MR signal may be dependent on eye movement and/or position, certain embodiments of the magnetic resonance eye tracking systems mathematically/statistically establish this dependence through a calibration or training stage and exploit this dependence for eye tracking in the rest of the study. In other words, certain embodiments of magnetic resonance eye tracking systems are based on a mathematical/statistical relationship between the MR signal and the position of the eyes. Note that “study” is used herein to refer to a period of time in which a subject is inside or otherwise exposed to scan signals emanating from a scanner continuously (as opposed to interrupted, such as by undergoing a scan in the morning and returning in the evening for an additional scan). Additionally, within a study, the calibration may be implemented in the beginning, the end, or any time in between with no particular preference for any time slot as long as the subject's head position remains fixed. The magnetic resonance eye tracking systems have a nominal hardware investment, and are easy to use. Thus, the magnetic resonance eye tracking systems can potentially save thousands of dollars compared to many infrared-based systems, and save a significant amount of experimental set-up time.

Although described below in the context of a human subject and the gaze corresponding to a human subject's eyes, a “subject” as used herein can refer to any life form that comprises eyes or other movable, spatially directed sensory organs. Additionally, the MR signal can represent a reconstructed image volume, but in some embodiments, need not be limited as such. That is, in some cases, actual two-dimensional (2-D) or three-dimensional (3-D) images may not be required. For example, certain embodiments of the magnetic resonance eye tracking systems may detect changes in eye orientation (e.g. is the person fixating at the right location or not) using a few specially acquired MR signals.

Further, although described in the context of functional magnetic resonance imaging (fMRI), it should be appreciated by those having ordinary skill in the art in the context of this disclosure that other MR data and modeling approaches can be used in some embodiments. For instance, some embodiments may utilize other applications of MRI where simultaneous eye position/movement is desired.

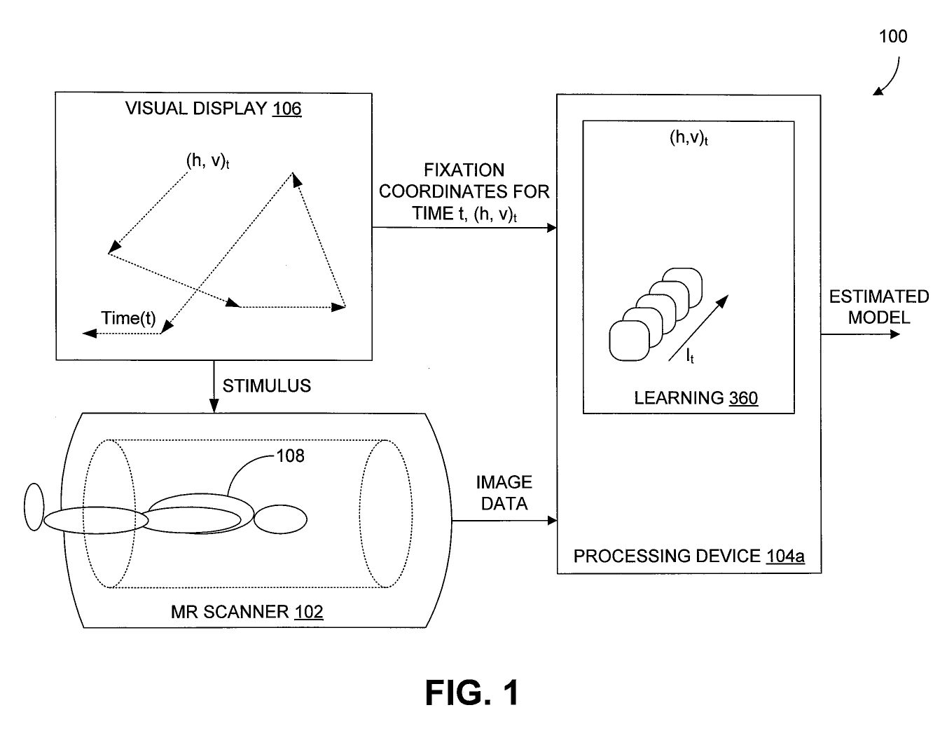

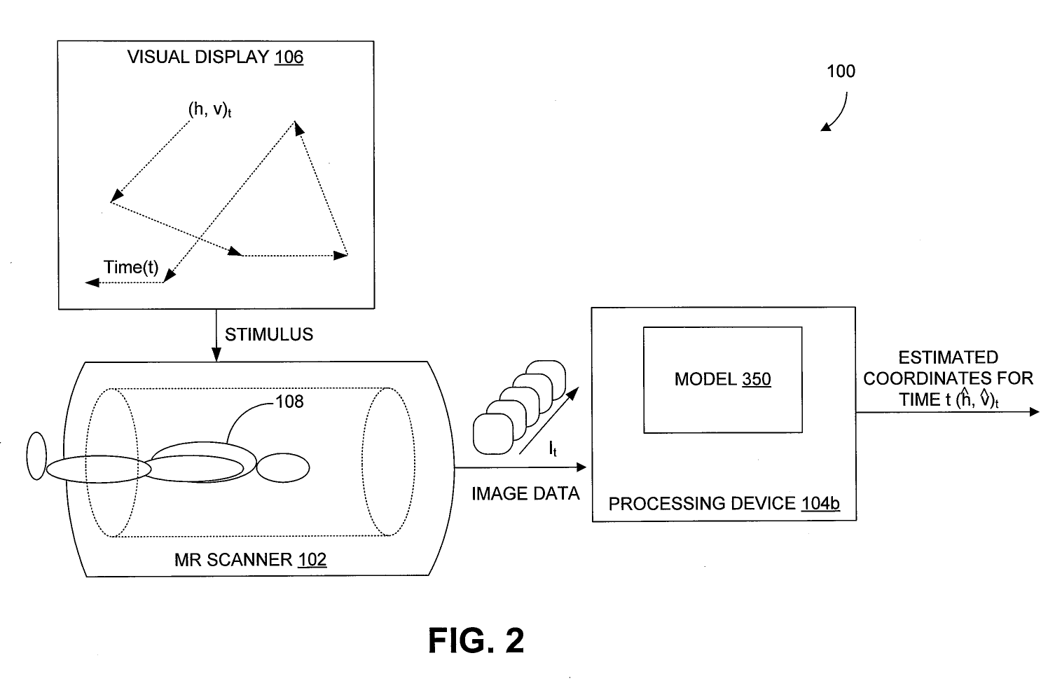

FIG. 1 is a functional block diagram that illustrates an embodiment of a magnetic resonance eye tracking system 100. The magnetic resonance eye tracking system 100 comprises a magnetic resonance device or MR scanner 102, a processing device 104a, and a visual display 106. Note that processing device 104a comprises one portion of a processing device 104, the other portion, designated 104b, shown in, and described in association with, FIG. 2. Although shown as separate components, it should be understood by one having ordinary skill in the art in the context of the present disclosure that functionality of each component can be located in a single device in some embodiments, or distributed among additional components not shown. In operation, a human volunteer is shown as a subject 108 resting in the MR scanner 102. During a calibration or training session (stage) or run, the subject 108 is able to see a visual stimulus provided on the visual display 106. This stimulus is generated in one embodiment by the processing device 104a. The stimulus directs the subject 108 to fixate on a symbol at a particular (known) horizontal and vertical location (h, v) within the subject's visual field. In the visual display 106, the symbol is shown at various positions for a predetermined time period, these changed positions represented using dotted lines with arrowheads.

Although described herein in conjunction with a visual display 106, a stimulus can embody any visual display or even any other sensory modulation that constitutes a natural or instructed relationship between eye fixation and that stimulus. In some embodiments, the subject 108 can generate the stimulus. The visual display 106 may be embodied as a visual, computer-generated display seen through goggles or projected onto a visual screen. Other stimuli that can be used in some embodiments include an auditory signal that can be spatially localized by the subject 108 (e.g. left/right emanating sounds), or instructions to move eyes based on tactile stimuli (e.g. “move eyes to the right when you feel a sensation (such as from a pulse of air) on your right hand”), among others.

By changing the location of a fixation symbol, images (e.g., image data) are transferred to the processing device 104a, the latter which comprises logic (e.g., learning module 360, explained below) to estimate a model or models that relates each image volume for a particular time to the fixation location (e.g., fixation coordinates for time t, or (h,v)ₜ) at that time. The model may be a mathematical formula, or in some embodiments, may be a lookup table. In particular, the input to the processing device 104a is multivariate. The processing device 104a comprises mathematical tools that enable extraction of salient information (e.g. features) from this multivariate input data. The training or calibration stage establishes the most relevant features to extract and the relationship between the feature(s) and the eye positions. The model parameters fitted from the calibration data may be represented as a matrix, and in some embodiments, may be used to generate a lookup table. While calibration data is collected during a training session (e.g., approximately 1-2 minutes), such data may be collected before or after the actual data of interest.

Now that an exemplary description of how a model is determined has been provided above, reference is now made to the functional block diagram shown in FIG. 2. The magnetic resonance eye tracking system 100 comprises the MR scanner 102 and the visual display 106 as explained above, and a processing device 104b, the latter which represents the second portion of a processing device 104 (the first portion, 104a, shown in FIG. 1). The processing device 104b comprises logic (e.g., model application module 350) for applying the model to MR input data (e.g., image data corresponding to a non-calibration scan or run). For instance, the mathematical model determined by the processing device 104a (FIG. 1) is applied to MR data during other non-training sessions (e.g., during a normal MR scan session) to estimate the subject's eye fixation in sessions where eye tracking is desired. Thus, in one embodiment, a multivariate model is used with pixel intensities as input variables and one, two, or three-dimensional coordinates provided as the response variables. Note that the subject 108 may be looking at a similar picture (e.g., similar to that seen during the calibration stage), a different type of picture, or no picture at all on the visual display 106. In one implementation, for instance, MR data is collected with similar imaging parameters (related to the MR physics and type and quality of images acquired) with little to no constraint on the visual stimulus and/or eye fixation direction. Eye positions outside the range of those collected during calibration may result in extrapolation from the calibration data. Additionally, the type of images collected at the scanner 102 can be different (and thus the differences are modeled), and the fixation locations may be different as well.

Note that although described using the same subject 108 in the same head orientation between calibration and standard MR scan sessions within a study, the magnetic resonance eye tracking system 100 is not limited to such implementations. Preferably, a model is generated as the result of a calibration session while a subject's head is in the same position and close in time (e.g., within the same study). However, a model may be generated by calibrating on the same subject in a separate scanning session (e.g., same study yet not close in time, or in a different study) and with a slightly different head position. In this latter circumstance, a 3-D image registration algorithm may be applied to register the calibration data and experimental data to the same 3-D space (e.g., using auxiliary data such as very high resolution images).

Additionally, though less desirable, a different subject may be used between calibration and normal sessions (and thus, different study). In this latter implementation, registration to another's (e.g., another individual or group) model, similar to that described above for differences in head position, is one approach to be used.

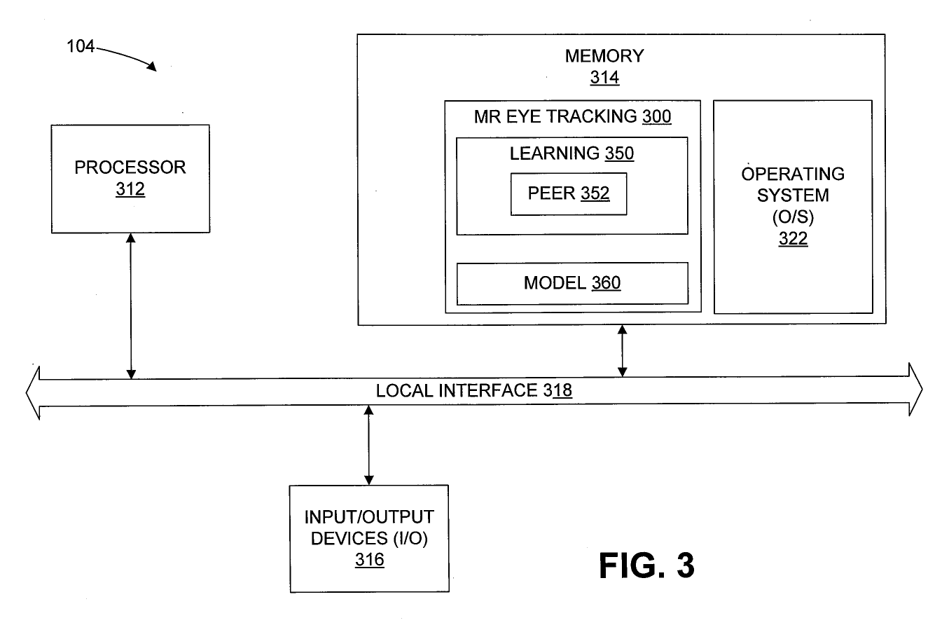

Having described one embodiment of a magnetic resonance eye tracking system 100, reference is now made to FIG. 3 to describe an embodiment of the processing device 104 (comprising logic and functionality of processing devices 104a and 104b). In particular, FIG. 3 is a block diagram showing a configuration of the processing device 104 that in one embodiment comprises magnetic resonance eye tracking software. In FIG. 3, the magnetic resonance eye tracking software is denoted by reference numeral 300. Note that in some embodiments, the magnetic resonance eye tracking software 300 may incorporate one or more additional elements (e.g., modules) not shown in FIG. 3, or fewer elements than those shown in FIG. 3. In some embodiments, some or all of the functionality of the magnetic resonance eye tracking software 300 may be embodied in an application specific integrated circuit (ASIC) or other processing device(s) embedded in the MR scanner 102, or in another device external to the MR scanner 102.

Generally, in terms of hardware architecture, the processing device 104 includes a processor 312, memory 314, and one or more input and/or output (I/O) devices 316 (or peripherals) that are communicatively coupled via a local interface 318. The local interface 318 may be, for example, one or more buses or other wired or wireless connections. The local interface 318 may have additional elements such as controllers, buffers (caches), drivers, repeaters, and receivers, to enable communication. Further, the local interface 318 may include address, control, and/or data connections that enable appropriate communication among the aforementioned components.

The processor 312 is a hardware device for executing software, particularly that which is stored in memory 314. The processor 312 may be any custom made or commercially available processor, a central processing unit (CPU), an auxiliary processor among several processors associated with the magnetic resonance eye tracking software 300, a semiconductor-based microprocessor (in the form of a microchip or chip set), a macroprocessor, or generally any device for executing software instructions.

The I/O devices 316 may include input devices such as, for example, a keyboard, mouse, scanner, microphone, etc. Furthermore, the I/O devices 316 may also include output devices such as, for example, a printer, display, etc. Finally, the I/O devices 316 may further include devices that communicate both inputs and outputs such as, for instance, a modulator/demodulator (modem for accessing another device, system, or network), a radio frequency (RF) or other transceiver, a telephonic interface, a bridge, a router, etc.

The memory 314 may include any one or combination of volatile memory elements (e.g., random access memory (RAM)) and nonvolatile memory elements (e.g., ROM, hard drive, etc.). Moreover, the memory 314 may incorporate electronic, magnetic, optical, and/or other types of storage media. Note that the memory 314 may have a distributed architecture in which various components are situated remotely from one another but may be accessed by the processor 312.

The software in memory 314 may include one or more separate programs, each of which comprises an ordered listing of executable instructions for implementing logical functions. In the example of FIG. 3, the software in the memory 314 includes the magnetic resonance eye tracking software 300, which in one embodiment comprises the learning module 350 and the model application module 360 (corresponding, for instance, to logic and functionality pertaining to processing device 104a and 104b, respectively). In some embodiments, the magnetic resonance eye tracking software 300 can be implemented as a single module with all of the functionality of the aforementioned modules 350 and 360, or in some embodiments, be further distributed among additional modules residing in the same or different devices. The software in memory 314 also includes a suitable operating system (O/S) 322. The operating system 322 essentially controls the execution of other computer programs, such as the magnetic resonance eye tracking software 300, and provides scheduling, input-output control, file and data management, memory management, and communication control and related services.

The magnetic resonance eye tracking software 300 is a source program, executable program (object code), script, or any other entity comprising a set of instructions to be performed. As described previously, the magnetic resonance eye tracking software 300 can be implemented, in one embodiment, as a distributed network of modules, where one or more of the modules can be accessed by one or more applications or programs or components thereof.

The learning module 350 is configured to provide a stimulus that prompts the fixation of a subject's gaze, and is further configured to relate magnetic resonance data to fixation coordinates prompted by a stimulus or stimuli imposed on a subject and generate a model to be used in estimating eye fixation for a subject. In one embodiment, the learning module 350 implements a predictive eye estimation regression (PEER) algorithm 352 to determine fixation on an image-by-image basis. That is, the PEER algorithm 352 comprises a calibration or training session as described herein and the execution of a regression algorithm such as support vector regression (SVR), among others. In such an approach, eye-tracking calibration takes place during a preliminary or training imaging run whose sequence parameters (e.g., slice prescription, repetition time (TR), echo time (TE), flip angle, bandwidth, etc.) match those of the magnetic resonance imaging scans in the same study. Note that the image scans of the training session may be used to determine direction of gaze as well, although redundant to the implementation of the PEER algorithm. The learning module 350 further implements SVR to model each calibration image and its corresponding (known) fixation location. This model can then be used to predict eye fixation for other images in the study (e.g., using identical sequence parameters). In one embodiment, a separate regression model is used for horizontal and vertical fixations, although not necessarily limited to using separate regression models.

Other mathematical/statistical models besides SVR can be applied in some embodiments. For instance, SVR can be replaced with like-approaches used in different scientific disciplines (e.g., mathematics, statistics, pattern recognition, machine learning, etc.). Other current alternatives include, but are not limited to, neural networks, general linear model (GLM), multivariate adaptive regression splines (MARS), ridge regression, and Lasso regression. Such alternative regression approaches include empirically derived regression models, models based on first principles of MR physics and tissue material properties, among others.

The model application module 360 is configured to apply magnetic resonance data to the model generated by the learning module 350. That is, the aforementioned calibration model or models generated by the learning module 350 can be used by the model application module 360 to estimate the horizontal and vertical locations during other MR scan sessions. Note that more than a single model may be generated, such as individual horizontal and vertical models, or equivalent models can be combined, such as SVR and Lasso.

When the magnetic resonance eye tracking software 300 is a source program, then the program is translated via a compiler, assembler, interpreter, or the like, which may or may not be included within the memory 314, so as to operate properly in connection with the O/S 322. Furthermore, the magnetic resonance eye tracking software 300 can be written with (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada.

When the magnetic resonance eye tracking software 300 is in operation, the processor 312 is configured to execute software stored within the memory 314, to communicate data to and from the memory 314, and to generally control operations of the magnetic resonance eye tracking software 300 pursuant to the software. The magnetic resonance eye tracking software 300 and the O/S 322, in whole or in part, but typically the latter, are read by the processor 312, buffered within the processor 312, and then executed.

When the magnetic resonance eye tracking software 300 is implemented all or primarily in software, as is shown in FIG. 3, it should be noted that the magnetic resonance eye tracking software 300 can be stored on any computer-readable medium for use by or in connection with any computer-related system or method. In the context of this document, a computer-readable medium is an electronic, magnetic, optical, or other physical device or means that can contain or store a computer program for use by or in connection with a computer related system or method. The magnetic resonance eye tracking software 300 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In addition, the scope of the present disclosure includes embodying the functionality of the preferred embodiments in logic embodied in hardware or software-configured mediums.

In an alternative embodiment, where functionality of the magnetic resonance eye tracking software 300 is implemented in whole or in part in hardware, such functionality can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc; or can be implemented with other technologies now known or later developed.

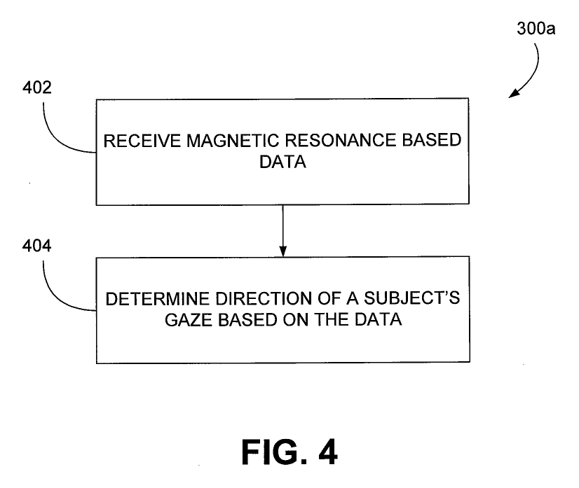

In view of the above description, it should be appreciated that one embodiment of a magnetic resonance eye tracking method 300a, illustrated in FIG. 4, comprises receiving magnetic resonance based data (402) and determining a direction of a subject's gaze based on the data (404). Such determination of a subject's gaze also includes the ability to detect changes in eye orientation.

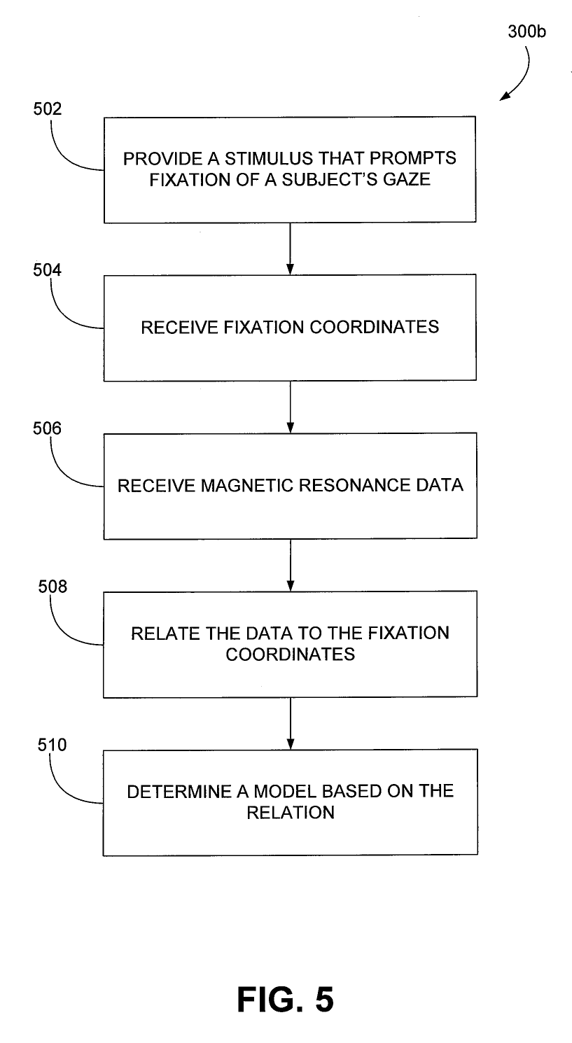

In view of the above description, it should be appreciated that one embodiment of a magnetic resonance eye tracking method 300b (and in particular, functionality corresponding to the learning module 350 and PEER algorithm 352), illustrated in FIG. 5, comprises providing a stimulus that prompt's fixation of a subject's gaze (502), receiving fixation coordinates (504), receiving magnetic resonance data (506), relating the data to the fixation coordinates (508), and determining a model based on the relation (510).

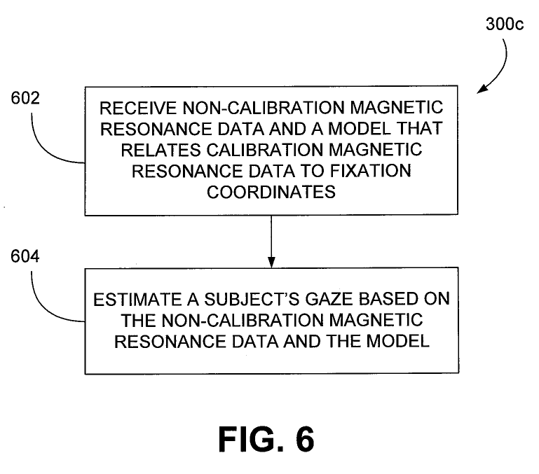

In view of the above description, it will be appreciated that one embodiment of a magnetic resonance eye tracking method 300c (and in particular, functionality corresponding to the model application module 360), illustrated in FIG. 6, comprises receiving non-calibration magnetic resonance data and a model that relates calibration magnetic resonance data to fixation coordinates (602), and estimating a subject's gaze based on the non-calibration magnetic resonance data and the model (604).

Any process descriptions or blocks in flow charts should be understood as representing modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present disclosure. Further, it should be understood that the methods shown in, and described in association with, FIGS. 4-6, are not limited to the embodiments shown in FIGS. 1-3.

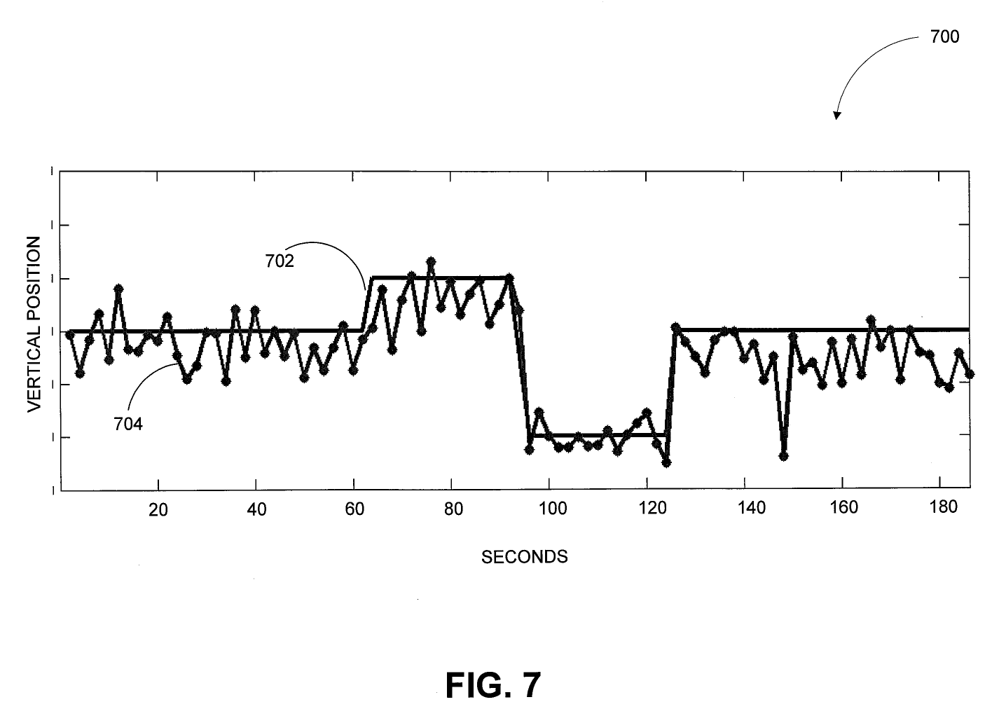

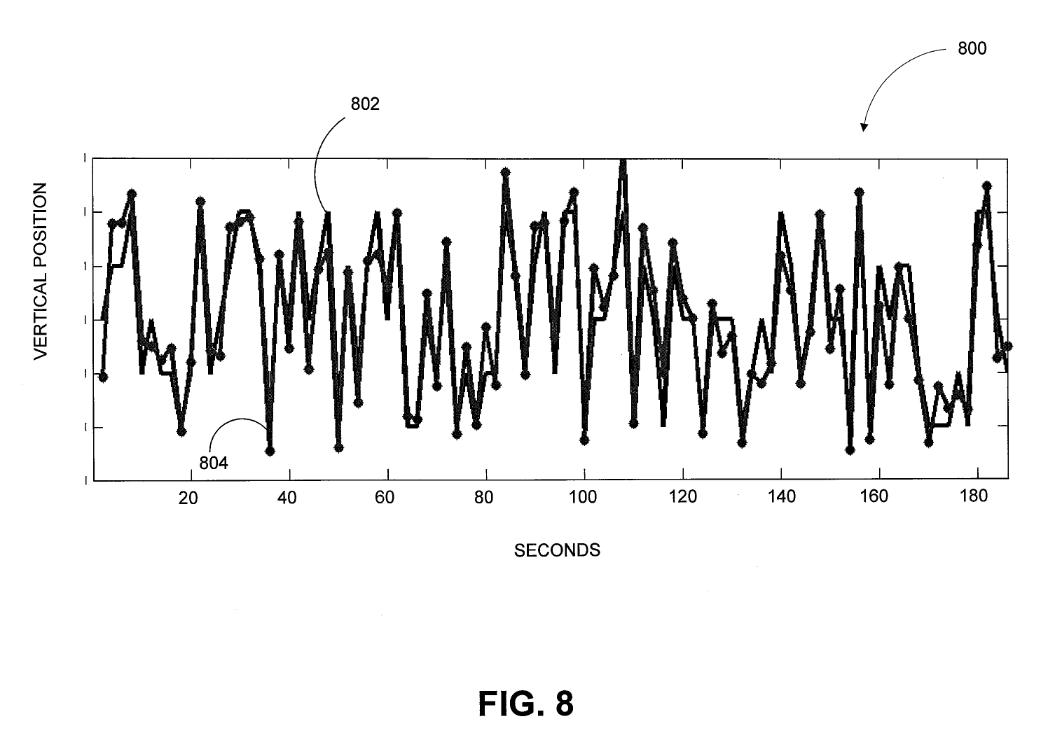

FIGS. 7 and 8 include schematic diagrams 700 and 800, respectively, that illustrate vertical tracking for a single subject based on the methods shown in FIGS. 4-6. These diagrams 700 and 800 are the result of a data collection (functional MRI data) with 27 axial EPI slices (TR/TE=2003/31 msec, voxel=3.4×3.4×5 mm) for an experimental set-up. As a brief overview of the set-up, back projection was used to a mirror mounted within a head coil, a visual field of approximately 20 degrees horizontal and 15 degrees vertical was provided. For each of three volunteers, three imaging runs were performed according to the following specifications, each run having a duration of approximately one minute. In a calibration run, the volunteer focused their gaze on a fixation symbol that moved to a random location on a display at each TR. The second run consisted of the volunteer fixating on a symbol placed at the center of the visual field for approximately one minute, followed by two 30-second fixation periods with the symbol off center (i.e., above and to the right of center, and below and to the left of center), and then returning to the center fixation for the final minute. The third run matched the first calibration run (except with a new randomization). The first run was modeled using a multivariate SVR, using a separate regression for horizontal and vertical fixations. Such calibration models were used to estimate the horizontal and vertical locations for the latter two runs.

Referring now to FIG. 7, diagram 700 shows a representation of the fixation run (vertical position as a function of time), with line 702 representing the symbols positions and line 704 representing the estimated tracking. Referring to FIG. 8, diagram 800 shows a representation of the random position changes at each TR for the last run (vertical position as a function of time), with line 802 representing the symbols positions and line 804 representing the estimated tracking. As revealed in FIG. 8, estimated tracks well with the symbol positions. Note that horizontal tracking, though not shown, tended in this experiment to be comparable or slightly worse than the vertical results in terms of goodness of fit (e.g., horizontal correlations ranged from 0.65 to 0.85 for the three subjects compared to vertical correlations of 0.78 to 0.92).

Note that, although a specific implementation utilizing a standard pulse sequence frequently (but not exclusively) performed in fMRI experiments is described, numerous other known and future pulse sequences can be used in some embodiments. Further, very rapid eye movements, such as saccades, may require faster sampling frequencies. Additionally, the use of the PEER algorithm 352 does not alter fMRI results, and as a retrospective analysis tool, can be used at any fMRI site. As such, calibration runs can be acquired at any point in a scanning session.

Note that some embodiments may utilize conventional or future techniques in combination with the magnetic resonance eye tracking software 300 to improve the accuracy of the estimate. For instance, IR based eye tracking systems may be used with the magnetic eye tracking software 300 in some embodiments to provide an estimate (or improved estimate) of the true direction of a subject's gaze.

It should be emphasized that the above-described embodiments of the present disclosure, particularly, any “preferred” embodiments, are merely possible examples of implementations, merely set forth for a clear understanding of the principles of the disclosed systems and methods. Many variations and modifications may be made to the above-described embodiment(s) without departing substantially from the spirit and principles of the disclosure. All such modifications and variations are intended to be included herein within the scope of this disclosure.

At least the following is claimed:

1. A magnetic resonance eye tracking method, comprising:
receiving magnetic resonance based data; and
determining direction of a subject's gaze based on the data.

2. The method of claim 1, wherein determining the direction further comprises determining an amount of eye movement.

3. The method of claim 1, wherein receiving the magnetic resonance based data comprises receiving the magnetic resonance based data during a non-calibration scan.

4. The method of claim 3, wherein determining the direction further comprises combining a regression model based on second magnetic resonance based data from a calibration scan with the magnetic resonance based data from the non-calibration scan.

5. The method of claim 4, wherein responsive to the combining, estimating horizontal and vertical fixation locations corresponding to the subject's gaze corresponding to the non-calibration scan.

6. The method of claim 4, wherein the calibration scan is implemented before the non-calibration scan.

7. The method of claim 4, wherein the calibration scan is implemented after the non-calibration scan.

8. The method of claim 4, wherein the regression model relates an image volume corresponding to the second magnetic resonance based data for a defined time to a fixation location at that time.

9. The method of claim 8, wherein the regression model comprises one of a look-up table and a math formula.

10. The method of claim 4, wherein combining further comprises combining more than one regression model.

11. The method of claim 4, further comprising prompting generation of the second magnetic resonance based data by providing a stimulus to the subject or a different subject.

12. The method of claim 4, wherein the second magnetic resonance based data corresponds to the subject or a different subject.

13. A magnetic resonance eye tracking system, comprising:
memory with software stored therein; and
a processor configured with the software to:
receive first eye fixation coordinates and first image data corresponding to a calibration scan;
generate one or more models based on the first eye fixation coordinates and the first image data;
receive second image data corresponding to a non-calibration scan; and
estimate a subject's eye fixation based on the second image data and the one or more models.

14. The system of claim 13, wherein the processor is further configured with the software to output estimated eye fixation coordinates.

15. The system of claim 13, wherein the processor is further configured with the software to prompt generation of the first eye fixation coordinates by generating a stimulus.

16. The system of claim 15, wherein the stimulus comprises visual stimuli, non-visual stimuli, or a combination of both.

17. The system of claim 13, wherein the one or more models relates an image volume corresponding to the second image data for a defined time to a eye fixation location corresponding to the first eye fixation coordinates at that time.

18. The system of claim 13, wherein the processor is further configured with the software to estimate horizontal, vertical, or a combination of horizontal and vertical eye fixation coordinates.

19. The system of claim 13, wherein the processor and the memory are embodied in a magnetic resonance imaging scanner or coupled to a magnetic resonance imaging scanner.

20. A computer readable medium having a magnetic resonance eye tracking program, the program for performing the steps of:
generating a model based on first magnetic resonance based data received during a calibration stage;
receiving second magnetic resonance based data during a non-calibration stage; and
determining direction of a subject's gaze based on the model and the second magnetic resonance based data.
